(19) United States
(12) Patent Application Publication
(10) Pub. No.: US 2026/0322874 A1
(43) Pub. Date: Oct. 15, 2026

(54) STORAGE ARRAY BASED NON-DISTRUPTIVE MIGRATION

(71) Applicant: Dell Products L.P., Round Rock, TX (US)

(72) Inventors: Utkarsh Dubey, Bangalore (IN); Nida Taranum, Bangalore (IN); Bharadwaj R. Sathavalli, Bangalore (IN)

(73) Assignee: Dell Products L.P., Round Rock, TX (US)

(21) Appl. No.: 19/174,208

(22) Filed: Apr. 9, 2025

(51) Int. Cl. H04L 67/1097; H04L 67/133; H04L 67/148

(52) U.S. Cl. CPC H04L 67/1097; H04L 67/133; H04L 67/148

(57) ABSTRACT

Native integration of non-disruptive storage migration to a orchestration platform, such as Kubernetes persistent volume claims (PVCs), is achieved with a custom resource (CRD), representing migration instances, and custom controllers to respond to the actions on those custom resource instances. A request to migrate a containerized application from a first array to a second array is received. A migration array container running as a sidecar to a CSI driver generates a custom resource defining a migration group. A migration initiation request from the custom resource is generated and a migration session is established by the CSI driver. A second container performs a rescan of the second array during the migration session and the CSI driver executes a commit operation on the migration session, completing the migration.

### BACKGROUND

As part of hardware upgrade or technology refresh activities, storage array users often replace older platforms of storage arrays with latest or updated platforms supported by storage vendors. To support the set of data intensive applications where data availability is critical, storage vendors provide non-disruptive migration (NDM) features to allow migration of volumes from older platforms to newer platform without disruption.

When orchestrated volumes, such as Kubernetes persistent volume claims (PVCs) are deployed on a cluster which uses an external provisioner with a network attached storage (NAS) or storage area network (SAN) backend, there is no mechanism to support non-disruptive migration of these PVCs across platforms. Currently, users are expected to take backups from the older platform using external software solutions built on top of the orchestration platform and then restore the PVCs on the new platform. Downtime is unavoidable in these implementations, and the prescribed methodology is resource intensive.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

According to one aspect, a method includes receiving a request to migrate a containerized application from a first array to a second array. A first container may generate a custom resource defining a migration group and generate a migration initiation request from the custom resource. A container storage interface (CSI) driver may generate a migration session based on the migration initiation request between the first array and the second array. The second container may execute a rescan of the second array during the migration session. The CSI driver may execute a commit operation on the migration session.

According to another aspect, a system may include a memory; and at least one processor that is operatively coupled to the memory, the at least one processor being configured to perform the operations of receiving a request to migrate a containerized application from a first array to a second array. A first container may generate a custom resource defining a migration group and generate a migration initiation request from the custom resource. A CSI driver may generate a migration session based on the migration initiation request between the first array and the second array. The second container may execute a rescan of the second array during the migration session. The CSI driver may execute a commit operation on the migration session.

According to another aspect, a non-transitory computer-readable medium storing one or more processor-executable instructions, which when executed by at least one processor cause the at least one processor to perform the operations of receiving a request to migrate a containerized application from a first array to a second array. A first container may generate a custom resource defining a migration group and generate a migration initiation request from the custom resource. A CSI driver may generate a migration session based on the migration initiation request between the first array and the second array. The second container may execute a rescan of the second array during the migration session. The CSI driver may execute a commit operation on the migration session.

The method, system and non-transitory computer-readable medium may further include, alone or in combination, one or more of the following features. The application may be hosted by a container orchestration system. The container orchestration system maybe a Kubernetes platform. The first container may be a sidecar controller to the CSI driver. The second container may be a sidecar controller of the CSI driver. The first container and the second container may communicate with the CSI driver through a remote procedure call (RPC). Establishing a migration session may include creating a target volume in the second array based on the migration group of the custom resource. The application may be removed from the first array.

### BRIEF DESCRIPTION OF THE DRAWINGS

Other aspects, features, and advantages of the claimed invention will become more fully apparent from the following detailed description, the appended claims, and the accompanying drawings in which like reference numerals identify similar or identical elements. Reference numerals that are introduced in the specification in association with a drawing figure may be repeated in one or more subsequent figures without additional description in the specification in order to provide context for other features.

FIG. 1A is a diagram of an example of a storage system, according to one or more aspects of the present disclosure;

FIG. 1B is a diagram of orchestration platform cluster with an interface driver, according to one or more aspects of the present disclosure;

FIG. 2 is a block diagram of an array migration implementation, according to one or more aspects of the present disclosure;

FIG. 3 is an example custom resource definition, according to one or more aspects of the present disclosure;

FIG. 4 is a block diagram of an array migration environment including sidecar controllers and their components, according to one or more aspects of the present disclosure;

FIG. 5 is a control flow diagram for migrating arrays, according to one or more aspects of the present disclosure;

FIG. 6 is a state flow diagram of a custom resource, according to one or more aspects of the present disclosure;

FIG. 7 is a diagram of an example of a computing device, according to aspects of the disclosure.

### DETAILED DESCRIPTION

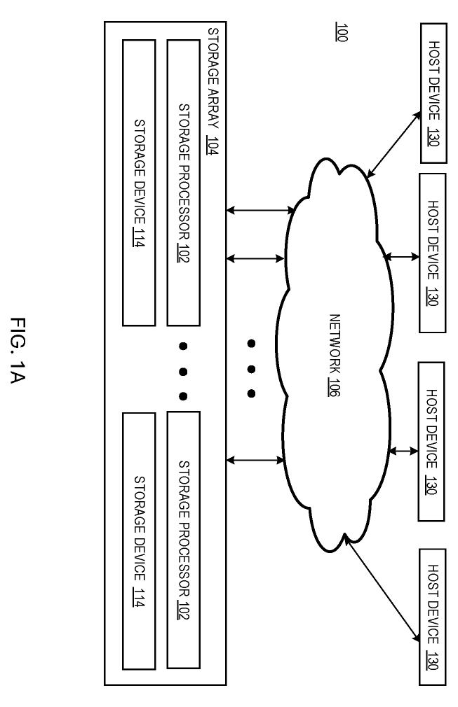

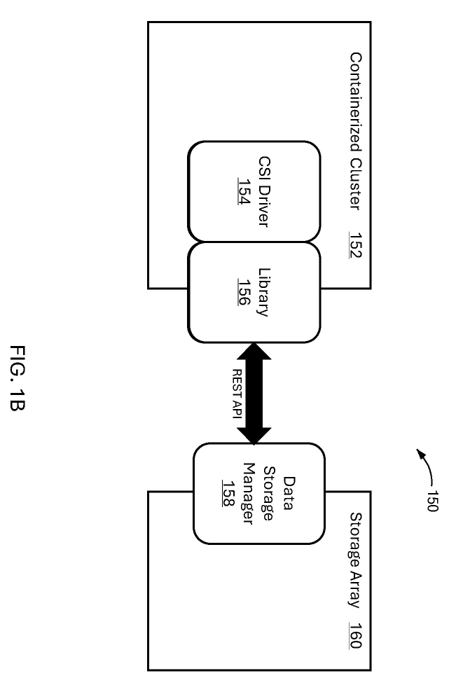

FIG. 1A is a diagram of an example of a storage system 100, according to aspects of the disclosure. As illustrated, the system 100 may include a storage array 104, a communications network 106, and a plurality of host devices 130. The communications network 106 may include one or more of a fibre channel (FC) network, the Internet, a local area network (LAN), a wide area network (WAN), and/or any other suitable type of network. The storage array 104 may include a storage system, such as DELL/EMC Powermax TM, DELL PowerStore TM, and/or any other suitable type of storage system. Each of the storage processors 102 may be configured to receive I/O requests from host devices 130 and execute the received I/O requests by reading and/or writing data to storage devices 114. Each of the host devices 130 may include a desktop computer, a laptop, a smartphone, an internet-of-things (IoT) device, and/or any other suitable type of computing device.

According to one aspect, each of storage devices 114 may be a non-volatile memory express (NVMe) drive. In another aspect, the storage devices may be solid-state drives (SSD). In some implementations, each of the storage devices 114 may be connected to the storage processors 102 via a Peripheral Component Interconnect Express (PCIe) connection. Each of the storage devices 114 may include a respective controller (not shown) and storage medium (not shown). The controller of each storage device 114 may include processing circuitry that is configured to perform various tasks, such as the retrieval and storage of data on the medium, wear leveling, error handling, garbage collection, as well as other functions. The medium may include an array of NAND memory cells and/or any other suitable type of storage medium.

In some implementations, any of the storage devices 114 may be internal to one of the storage processors 102 and coupled to the storage processor via an M.2 slot that is provided on the motherboard of that storage processor. Additionally, or alternatively, in some implementations, any of the storage devices 114 may be part of a disk array enclosure (DAE) and coupled to each of the storage processors 102 via a respective InfiniBand adapter of that storage processor. It will be understood that the present disclosure is not limited to any specific method for connecting storage devices 114 to storage processors 102.

In some implementations, the storage processors 102 and the storage devices 114 may be located in geographically disparate locations. For example, the storage processors 102 may be distributed across multiple cities, countries, or continents. Similarly, the storage devices 114 (and/or the disk array enclosures of which they are part) may also be distributed across multiple cities, countries, or continents. Additionally, or alternatively, in some implementations, the storage processors 102 and the storage devices 114 may be located in the same geographic location, but in different buildings of the same campus (or different rooms of a large building).

FIG. 1B is a diagram of an orchestration environment 150 with an interface driver 154, according to one or more aspects of the present disclosure. Orchestration platforms, such as Kubernetes, are commonly used in cloud, private cloud, and on-premises datacenter environments. Container Storage Interface (CSI) is a standard for exposing storage systems in an arbitrary block and file storage to containerized workloads on container orchestrations like Kubernetes. CSI may help third-party storage providers to expose new storage systems without modifying the underlying orchestration platform code. CSI defines a set of standard interfaces to integrate storage in container orchestration systems, like the Kubernetes platform, to utilize storage technology for provision/deprovision storage, create/delete snapshots, and provision volume from snapshots. Data intensive applications may need seamless migration of containers and container groups (e.g., pods) from one backend array to another, particularly as part of hardware refresh and/or upgrade activities. However, neither the orchestration platforms nor the CSI specification defines an interface for integrating technology like non-disruptive array migration by which orchestrated containers and their applications can be efficiently migrated by the storage arrays.

Since a native interface is missing in such orchestration platforms, non-disruptive array migration of the external storage volumes attached to containers and pods is not possible. Known software solutions built on top of orchestration platform resources, like those in Kubernetes, utilize backup and restore resolutions to migrate containers and/or pods from one array to another and downtime is unavoidable.

Aspects of the present disclosure may be described herein as implemented in a Kubernetes platform, however those skilled in the art will recognize that the concepts, techniques and structures are not limited to Kubernetes implementations and other orchestration and application platforms, such as OpenShift and others, may be used without deviating from the scope of the disclosure.

As shown in the exemplary orchestration environment 150 of FIG. 1B, a containerized cluster 152, such a Kubernetes cluster, may include a CSI driver and one or more client libraries 156. Rather than implement API calls and request/response types, the client libraries may be used to handle certain tasks to interface with a data storage manager 158 of a storage array 160. According to one aspect, storage array 160 may be the same or similar to the storage array 104 described in connection with FIG. 1A.

Kubernetes may use the CSI specification for a number of purposes. The specification may include several methods that may be called to manage various aspects of the storage array and its configuration. The CSI specification may be used, for example, to create a volume (CreateVolume) on the array 160 based on specifications requested by the application via the ‘Storage Class’ in Kubernetes. The CSI specification may also be used to publish (ControllerPublishVolume) the volume to a node on Kubernetes via a fiber channel (FC) or Internet Small Computer System Interface (iSCSI) by creating a masking view on the array 160 using a Representational State Transfer (REST) API.

Another method (NodePublishVolume) may be used to discover and map the volume or logical unit number (LUN) previously created and mapped to the node, and to mount the LUN on a local directory inside the container. In another method, (NodeUnpublishVolume) may reverse operation of Node Publish Volume. Other methods may be used to reverse the operations of the controller publish volume (ControllerUnpublishVolume), delete a volume after its no longer needed (DeleteVolume), create a snapshot from a source volume (CreateSnapshots) and create a clone volume (CreateCloneVolume). As detailed herein, such methods and functionality may be used to provide an implementation for non-disruptive storage migration.

Aspects of the present disclosure may integrate non-disruptive migration techniques to the orchestration platform to promote seamlessness, efficiency, and cost-effectiveness and may avoid reliance on third-party, high-cost, host based, and disruptive software.

According to one or more aspects, native integration of non-disruptive storage migration to a orchestration platform, such as Kubernetes persistent volume claims (PVCs), may be achieved with a custom resource (CRD), representing migration instances, and custom controllers to respond to the actions on those custom resource instances. According to one aspect, storage providers supporting storage non-disruptive migration can enable the concepts, techniques and concepts described herein on the orchestration platform, using the custom resources.

Aspects of the present disclosure provide concepts, techniques and structures for providing non-disruptive migration implementations in one or more storage arrays, such as storage arrays 104, 160 described above, using an orchestration platform, such as the Kubernetes platform.

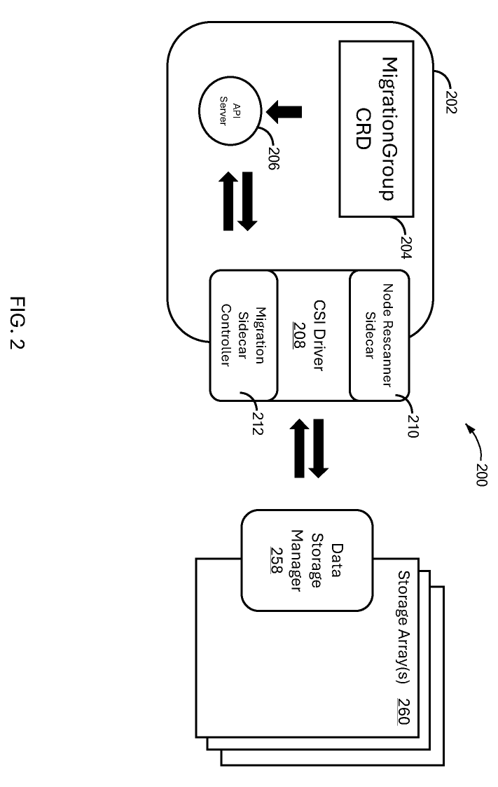

FIG. 2 is a block diagram of a non-disruptive storage array-based migration implementation 200. The exemplary implementation may provide storage array-based migration in a Kubernetes platform using custom resources and controllers to achieve migration of an array, such as array 260, managed by data storage manager 258, in a Kubernetes environment.

According to aspects of the exemplary implementation 200, an interface such as CSI driver 208 may be provided for users to manage and monitor migration between arrays directly from a Kubernetes cluster 202. An API server 206 may allow for the query and manipulation of object states in the Kubernetes cluster 202. The API server may expose an HTTP API that allows end users, different parts of the cluster 202, and external components to communicate with one another.

According to one aspect, a migration related construct, referred to herein as a migration group, may be defined. According to one aspect, the migration group may provide a way of grouping together a pair of one or more arrays 260. For example, all migration related activities, including creating, committing and migrating may be performed at this group level. A migration group may be a manifestation of a migration environment between a pair of arrays 260, such as in a DELL/EMC Powermax™ solution. The migration group may be represented by a newly generated custom resource of the same name on the Kubernetes cluster 202, here called MigrationGroup 204.

The non-disruptive migration environment 200 may further use two sets of containers, such as a Node Rescanner Sidecar 210 and a Migration Sidecar Controller 212 running as sidecars to the CSI driver 208. According to aspects of the disclosure, the controllers, as described herein, may monitor migration groups’ custom resources and augment them with additional migration-related metadata in the form of annotations and labels. The controllers may further synchronize the custom resources and facilitate the execution of various migration-related operations.

In addition to providing additional sidecar containers, like the Node Rescanner Sidecar 210 and the Migration Sidecar Controller 212, as well as custom resources, like the MigrationGroup CRD 204, the implementation 200 may add one or more extra endpoints in the CSI specification facilitating the discovery of migration related resources and data, as well as execution of migration related actions, possible directly from the cluster 202.

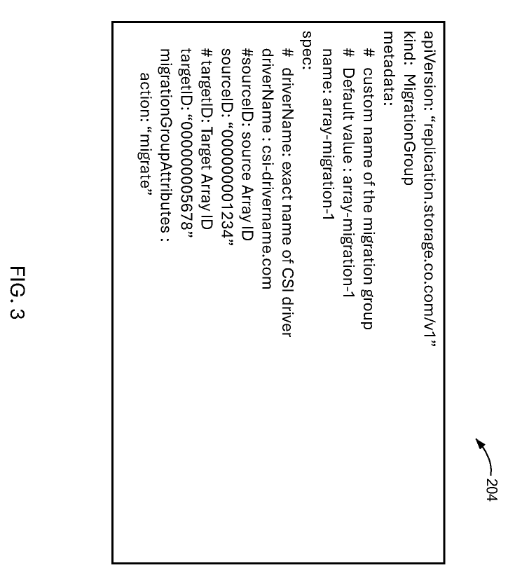

FIG. 3 depicts an exemplary custom resource, or CRD, similar to or the same as the MigrationGroup CRD 204. According to one aspect, the CRD 204 may be a template or include user-generated or editable fields, like those shown in FIG. 3. The MigrationGroup CRD 204 may be a cluster-scoped custom resource representing a group on an array to which all volumes with the same migration related properties belong. The CRD may include migration related metadata, including array details, configuration details and the driver name/location to use for the group. The CRD may be immutable except for its Action property, described below, which may be used for execution of various migration actions.

According to one or more aspects, the CRD may contain a number of fields. The “Name” field may include the name of the migration group, for example “array-migration-1”. The sourceID may contain or identify an array identifier of the source array. In one aspect, the sourceID may be a DELL/EMC VMAX3 or PowerMax array. TargetID may include an array identifier of the target array. In one aspect, the targetID may include or be a DELL/EMC VMAX All Flash or PowerMax array. DriverName may include the identification and/or location of the driver to use for migration. The Action field may include one or more parameters to execute various actions, such as “migrate” or “commit”.

The status of the CRD may include one or more fields reflecting the current migration state and/or CRD state. According to one aspect, a State field may include a parameter set by one of the sidecar controllers reflecting the current state of the migration group. The sidecar controllers may, according to one aspect, augment the CRD with the State field based on the current status of an on-going migration. This field may be visible in the CRD to a user, but not editable.

According to another aspect, the non-disruptive array migration implementation may provide an interface to a user to manage and monitor migration from the cluster. Accordingly, one or more extra endpoints to the CSI specification may be added. In one aspect, an API providing such an functionality may include an endpoint to create migration environments between arrays, an endpoint to create storage group migration sessions for the array volumes, an endpoint to perform migration actions on the migration group, such as migrate and commit, and an endpoint to delete the migration group.

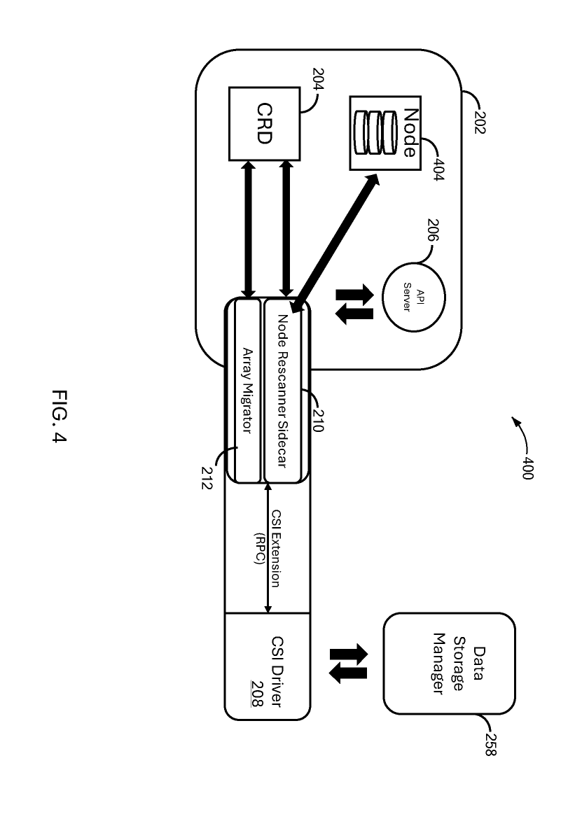

As detailed above, aspects of the present disclosure include the provision of sidecar controllers to facilitate migration-related operations. FIG. 4 is a block diagram of a non-disruptive migration environment 400 including the sidecar controllers, such as Node Rescanner Sidecar 210 and Array Migrator Sidecar 212. The environment 400 of FIG. 4 may be similar or the same as the environment 200 of FIG. 2, in which like reference numerals identify similar or identical elements. The controllers, according to aspects of the disclosure may run as sidecars to the CSI driver 208.

According to one aspect, the migration group controller or Array Migrator 212 may sit alongside the controller driver, CSI driver 208, and may be responsible for watching over the events on the migration group and interacting with the CSI driver via a CSI extension. The CSI extension may be or include a remote procedure call (RPC) generated for such a purpose. The CSI extension may include one or more RPC endpoints with their defined request and response structures in addition to one or more endpoints already present in the CSI interface specification. According to one aspect the CSI extension call may be a gRPC procedure. The Array Migrator controller 212 may be responsible for executing migration actions on the target storage groups and keeping the MigrationGroup CDR 204 up to date.

According to one aspect, the Node Rescanner Controller 210 may also sit alongside the CSI driver 208 and be configured to execute a full rescan on the node 404 once the migration sessions are active. The Node Rescanner Controller 210 may be configured to monitor the migration group and when instructed performs a SCSI-rescan of the node 404. This may result in new paths from the target array being identified and added for further use within the PVCs.

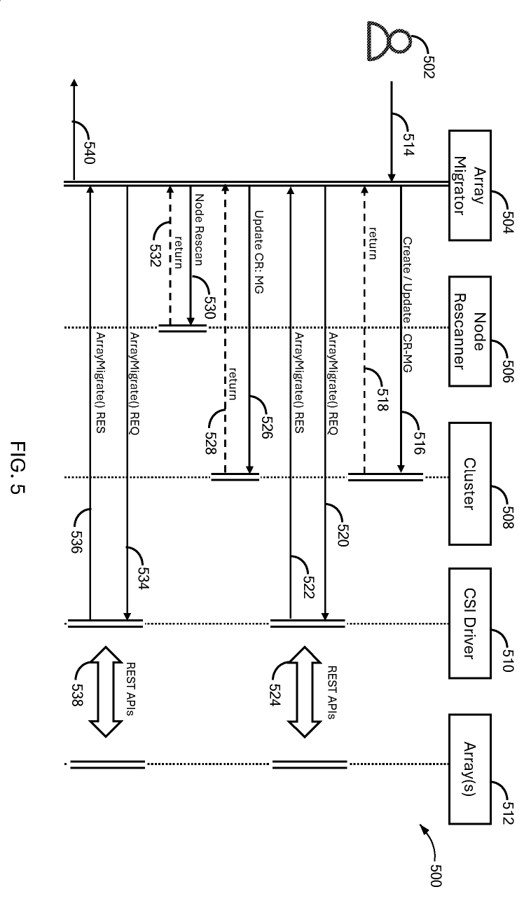

Turning now to FIG. 5, a control flow diagram 500 is shown including the flow scenario from creation and migration of a PVC to its deletion. The control flow 500 may include sending and receiving calls, requests, responses and the like between a user 502, components of a cluster, such as a Kubernetes cluster 508 hosting one or more applications, and one or more external storage devices, such as arrays 512. The Kubernetes cluster 508, as detailed herein, may include a CSI driver 510 configured to communicate with the arrays 512 through, for example REST APIs. The CSI driver 510 may include or feature as sidecar controllers an Array Migrator 504 and a Node Rescanner 506. The non-disruptive control flow may be configured to migrate orchestrated containers and their applications or application pods on the cluster 508 from one array to another.

A user or administrator 502 may initiate a migration operation 514 to the Migration Sidecar 504. Shown by arrow 516, the cluster 508 may have active application pods with associated PVCs and the custom resource, like the MigrationGroup CRD, installed for migration. The user may then update the migration group manifest (MigrationGroup CRD) with details of source, target arrays and creates the migration group (MG) object. A return call 518 is sent back to the Migration Sidecar 504.

The Array Migrator 504 may monitor the creation of the MG object and send the request (ArrayMigrator() REQ 520) to the CSI driver 510 to initiate migration. The CSI driver 510 may create a migration environment and migration sessions for the storage groups between the array pair. This results in the creation of a mirrored device on the target array for all the volumes on the source array to be migrated. The CSI driver 510 may returns the response 522 once all the mirrored devices are active.

The Array Migrator 504 may then read the response 522 from the CSI driver 510 and update 526 the MigrationGroup CRD to do a rescan on all the nodes with active application pods. A return response 528 is sent to the Array Migrator 504. The Node Rescanner 506, may read the request to do a rescan 530 on the node and proceeds with a SCSI-rescan on the system. Once completed, it may update the MigrationGroup CRD with a rescan done (return response 532).

The Array Migrator 504 then sends the ArrayMigrate() REQ 534 to the CSI driver 510 to perform a “COMMIT” action on the storage group sessions to finish the migration. The CSI driver 510 performs a commit on all migration sessions. This results in removal of the volumes from the source device and the I/O paths are transferred fully to the target array (e.g., a cutover). The CSI driver 510 then returns the response 536 back indicating that the migration is complete, which may be communicated to the user (540).

The user 502 may now delete the MG object performing the delete operation on the manifest MigrationGroup CRD. The Array Migrator 504 may receive a delete request from the user and send a delete request to the CSI driver 510. The CSI driver 510 may delete the migration environment on the array 512 and returns a response indicating the deletion. Then Array Migrator may remove the finalizer property set on the migration group by the orchestrator to protect the CRD from unauthorized deletion.

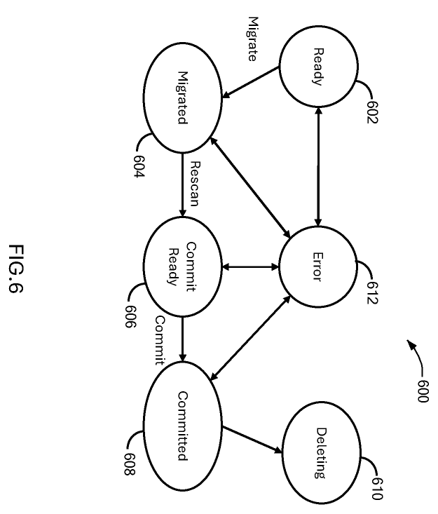

FIG. 6 is a state flow diagram of the MigrationGroup (MG) object as described herein. According to one aspect, the status or state of the MG object may be reflected as a state machine in the MigrationGroup CRD. The states of the MigrationGroup may include a Ready State 602, a Migrated state 604 and Commit Ready state 606, a Committed state 608, a Deleting state 610 and an Error state 612.

According to one aspect, when a request to migrate one or more applications is received, a migration group may be created, as described herein. The MigrationGroup CRD begins in the Ready state 602. The state may progress to the Migrated state 604 when the migration environment, and the MigrationGroup CRD are established with the details of the migration, including the source identifiers, target identifiers, and the like. From a cluster perspective, the migrate operation from Ready state 602 to Migrated state 604 may include adding the LUN of new array to a masking view, such that the cluster may have both LUN paths (e.g., the LUN of the source array and the LUN of the target array). When all of the migration details are updated, including establishing new paths from the cluster to the target array (in addition to the existing paths), a rescan operation may be executed to ensure all new paths are discovered and accounted for.

Once the rescan is complete, the MigrationGroup CRD may pass to the Commit Ready state 606. From the Commit Ready state 606, the Migration Group CRD may proceed to the Committed state 608 in which the array paths to the original array are removed leaving only the new paths to the new array. After entering a Committed state 608, with the applications and underlying objects migrated to the new array, the MigrationGroup CRD may move to the Deleting state 610 where the migration environment, migration group, objects and other data than are no longer used may be deleted.

The MigrationGroup CRD may also provide for an Error state 612 which may be entered at any point in the migration process where an error or fault may occur. Error checks may be implemented at each of the other states to ensure that all migration operations are successful. An error log may be generated and transmitted to a user reflecting any detected error or unsuccessful operation.

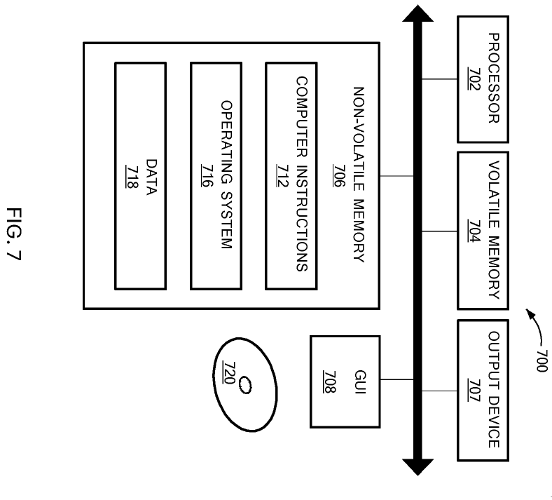

Referring to FIG. 7, in some embodiments, a computing device 700 may include processor 702, volatile memory 704 (e.g., RAM), non-volatile memory 706 (e.g., a hard disk drive, a solid-state drive such as a flash drive, a hybrid magnetic and solid-state drive, etc.), graphical user interface (GUI) 708 (e.g., a touchscreen, a display, and so forth) and input/output (I/O) device 720 (e.g., a mouse, a keyboard, etc.). Non-volatile memory 706 stores computer instructions 712, an operating system 716 and data 718 such that, for example, the computer instructions 712 are executed by the processor 702 out of volatile memory 704. Program code may be applied to data entered using an input device of GUI 708 or received from I/O device 720.

As used herein, the term “I/O request” or simply “I/O” may be used to refer to an input or output request. In some embodiments, an I/O request may refer to a data read or write request.

As used in this application, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used throughout the disclosure, the term “vector” refers to a sequence of numbers (and/or other elements). The phrase “the element having index i” refer to the i-th element in the sequence. For example, if i=1, the phrase i-th element in the sequence would refer to the first element in the sequence, if i=2, the phrase i-th element in the sequence would refer to the second element in the sequence, and so forth.

Additionally, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

To the extent directional terms are used in the specification and claims (e.g., upper, lower, parallel, perpendicular, etc.), these terms are merely intended to assist in describing and claiming the invention and are not intended to limit the claims in any way. Such terms do not require exactness (e.g., exact perpendicularity or exact parallelism, etc.), but instead it is intended that normal tolerances and ranges apply. Similarly, unless explicitly stated otherwise, each numerical value and range should be interpreted as being approximate as if the word “about”, “substantially” or “approximately” preceded the value of the value or range.

Moreover, the terms “system,” “component,” “module,” “interface,”, “model” or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Although the subject matter described herein may be described in the context of illustrative implementations to process one or more computing application features/operations for a computing application having user-interactive components the subject matter is not limited to these particular embodiments. Rather, the techniques described herein can be applied to any suitable type of user-interactive component execution management methods, systems, platforms, and/or apparatus.

While the exemplary embodiments have been described with respect to processes of circuits, including possible implementation as a single integrated circuit, a multi-chip module, a single card, or a multi-card circuit pack, the described embodiments are not so limited. As would be apparent to one skilled in the art, various functions of circuit elements may also be implemented as processing blocks in a software program. Such software may be employed in, for example, a digital signal processor, micro-controller, or general-purpose computer.

Some embodiments might be implemented in the form of methods and apparatuses for practicing those methods. Described embodiments might also be implemented in the form of program code embodied in tangible media, such as magnetic recording media, optical recording media, solid state memory, floppy diskettes, CD-ROMs, hard drives, or any other machine-readable storage medium, wherein, when the program code is loaded into and executed by a machine, such as a computer, the machine becomes an apparatus for practicing the claimed invention. Described embodiments might also be implemented in the form of program code, for example, whether stored in a storage medium, loaded into and/or executed by a machine, or transmitted over some transmission medium or carrier, such as over electrical wiring or cabling, through fiber optics, or via electromagnetic radiation, wherein, when the program code is loaded into and executed by a machine, such as a computer, the machine becomes an apparatus for practicing the claimed invention. When implemented on a general-purpose processor, the program code segments combine with the processor to provide a unique device that operates analogously to specific logic circuits. Described embodiments might also be implemented in the form of a bitstream or other sequence of signal values electrically or optically transmitted through a medium, stored magnetic-field variations in a magnetic recording medium, etc., generated using a method and/or an apparatus of the claimed invention.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments.

Also, for purposes of this description, the terms “couple,” “coupling,” “coupled,” “connect,” “connecting,” or “connected” refer to any manner known in the art or later developed in which energy is allowed to be transferred between two or more elements, and the interposition of one or more additional elements is contemplated, although not required. Conversely, the terms “directly coupled,” “directly connected,” etc., imply the absence of such additional elements.

As used herein in reference to an element and a standard, the term “compatible” means that the element communicates with other elements in a manner wholly or partially specified by the standard, and would be recognized by other elements as sufficiently capable of communicating with the other elements in the manner specified by the standard. The compatible element does not need to operate internally in a manner specified by the standard.

It will be further understood that various changes in the details, materials, and arrangements of the parts which have been described and illustrated in order to explain the nature of the claimed invention might be made by those skilled in the art without departing from the scope of the following claims.

What is claimed is:

1. A method comprising:
receiving a request to migrate a containerized application from a first array to a second array;
generating , by a first container, a custom resource defining a migration group;
generating, by the first container, a migration initiation request from the custom resource;
establishing, by a container storage interface (CSI) driver, a migration session based on the migration initiation request between the first array and the second array;
executing, by a second container, a rescan of the second array during the migration session; and
executing, by the container storage interface (CSI) driver, a commit operation on the migration session.

2. The method of claim 1 wherein the application is hosted by a container orchestration system.

3. The method of claim 2 wherein the container orchestration system is a Kubernetes platform.

4. The method of claim 1 wherein the first container is a sidecar controller to the CSI driver.

5. The method of claim 1 wherein the second container is a sidecar controller of the CSI driver.

6. The method of claim 1 wherein the first container and the second container communicate with the CSI driver through a remote procedure call (RPC).

7. The method of claim 1 wherein establishing a migration session comprises creating a target volume in the second array based on the migration group of the custom resource.

8. The method of claim 1 further comprising removing the application from the first array.

9. A system comprising:
a memory; and
at least one processor that is operatively coupled to the memory, the at least one processor being configured to perform the operations of:
receiving a request to migrate a containerized application from a first array to a second array;
generating, by a first container, a custom resource defining a migration group;
generating, by the first container, a migration initiation request from the custom resource;
establishing, by a container storage interface (CSI) driver, a migration session based on the migration initiation request between the first array and the second array;
executing, by a second container, a rescan of the second array during the migration session; and
executing, by the container storage interface (CSI) driver, a commit operation on the migration session.

10. The system of claim 9 wherein the application is hosted by a container orchestration system.

11. The system of claim 10 wherein the container orchestration system is a Kubernetes platform.

12. The system of claim 9 wherein the first container is a sidecar controller to the CSI driver.

13. The system of claim 9 wherein the second container is a sidecar controller of the CSI driver.

14. The system of claim 9 wherein the first container and the second container communicate with the CSI driver through a remote procedure call (RPC).

15. The system of claim 9 wherein the migration session comprises creating a target volume in the second array based on the migration group of the custom resource.

16. The system of claim 9 wherein the application is removed from the first array following the commit operation.

17. A non-transitory computer-readable medium storing one or more processor-executable instructions, which when executed by at least one processor cause the at least one processor to perform the operations of:
receiving a request to migrate a containerized application from a first array to a second array;
generating, by a first container, a custom resource defining a migration group;
generating, by the first container, a migration initiation request from the custom resource;
establishing, by a container storage interface (CSI) driver, a migration session based on the migration initiation request between the first array and the second array;
executing, by a second container, a rescan of the second array during the migration session; and
executing, by the container storage interface (CSI) driver, a commit operation on the migration session.

18. The non-transitory computer-readable medium of claim 17 wherein the first container is a sidecar controller to the CSI driver.

19. The non-transitory computer-readable medium of claim 17 wherein the second container is a sidecar controller of the CSI driver.

20. The non-transitory computer-readable medium of claim 17 wherein the first container and the second container communicate with the CSI driver through a remote procedure call (RPC).
